(19) United States
(12) Patent Application Publication
(10) Pub. No.: US 2026/0313209 A1
(43) Pub. Date: Oct. 8, 2026

(54) GENERATING SHORT VIDEOS FROM LIVE VIDEO STREAMS

(71) Applicant: Google LLC, Mountain View, CA (US)

(72) Inventors: Xinru Yang, San Mateo, CA (US); Hui Miao, Palo Alto, CA (US); Yi Zhang, Sunnyvale, CA (US); Yong-Gyun Choi, New York, NY (US); Jonathan Eric Nassau, New York, NY (US); Kalyan Ganapathisubramanian, San Jose, CA (US); Shun-Chuan Chen, Sunnyvale, CA (US); Ting Liu, Los Angeles, CA (US); Liangzhe Yuan, Los Angeles, CA (US); Hao Zhou, Santa Monica, CA (US); Kai Chen, San Bruno, CA (US)

(21) Appl. No.: 19/171,088

(22) Filed: Apr. 4, 2025

(51) Int. Cl. H04N 21/8549; G06F 40/35; G11B 27/036; G11B 27/34; H04N 21/2187; H04N 21/8547

(52) U.S. Cl. CPC H04N 21/8549; G11B 27/036; G11B 27/34; H04N 21/2187; H04N 21/8547; G06F 40/35

(57) ABSTRACT

Methods, systems, and apparatus, including computer programs encoded on computer storage media, for generating videos using neural networks. In one aspect, a live stream of video content is obtained. For each time interval in a plurality of successive time intervals during the live stream of the video content: a candidate short video is generated based on using a multi-modal neural network system to process a multi-modal input. One or more short videos are selected from the candidate short videos generated for the plurality of successive time intervals.

### BACKGROUND

This specification relates to processing video data using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

The Internet has facilitated the widespread dissemination of video data. For example, a client device can request a video from a video platform by submitting a request to the video platform, and the video platform can identify a video based on the request and then provide the identified video for presentation on the client device, e.g., by streaming the video to the client device.

A live video feed is a popular type of video data. A video may be referred to as a live video feed when the video includes new video frames that are continuously appended to the video as they become available. While the live video feed is being broadcasted, a live stream of video content may be generated. The live stream of video content includes one or more data streams that are associated with the live video feed.

For example, the live stream of video content can include a creator content stream that corresponds to a content creator that captures and broadcasts the live video feed, and one or more viewer content streams that each correspond to a respective content viewer that views the live video feed.

A short video is another popular type of video data in recent years. A short video, also known as a “short-form video,” refers to a video clip with a relatively short duration. Unlike conventional, long-form videos such as movies, webinars, documentaries, and TV series that are usually longer than 10 minutes, short videos are typically under a few minutes long, with many falling within the 15-60 second range. Short videos are often used in the context of social media platforms where viewers have shorter attention spans and prefer quick content consumption.

### SUMMARY

In general, one innovative aspect of the subject matter described in this specification can be embodied in methods that include the operations of: obtaining a live stream of video content that comprises a creator content stream and one or more viewer content streams, wherein the creator content stream comprises visual data and audio data provided by a content creator, and wherein each viewer content stream comprises action data that characterizes actions performed by a content viewer while observing the visual data and audio data provided by the content creator; for each time interval in a plurality of successive time intervals during the live stream of the video content: generating a candidate short video using a multi-modal neural network system to process a multi-modal input that comprises (i) a portion of the creator content stream that corresponds to the time interval and (ii) for each viewer content stream, a portion of the action data that characterizes actions performed by the content viewer within the time interval, wherein the candidate short video comprises a subset of video frames selected from video frames included in the creator content stream within the time interval and a subset of audio frames selected from audio frames included in the creator content stream within the time interval; selecting, from the candidate short videos generated for the plurality of successive time intervals during the live stream of the video content, one or more short videos; and providing the one or more selected short videos for presentation to the content creator.

These and other embodiments can each optionally include one or more of the following features.

The multi-modal input may comprise a text transcription of the speech uttered by the content creator. The method may comprise processing the audio data using an automatic speech recognition (ASR) model to generate the text transcription.

Each creator content stream may comprise action data that characterizes actions performed by the content creator while creating the visual data and audio data.

The multi-modal input may comprise metadata associated with the live stream of video content. The method may comprise obtaining the metadata that comprise one or more of: a downsampling rate of the video frames when being uploaded, or a frame rate of the video frames when being displayed.

Generating the candidate short video based on using the multi-modal neural network system may comprise: processing, by the multi-modal neural network system and for each time interval in the plurality of successive time intervals, the multi-modal input to generate an output that comprises a beginning timestamp and an ending timestamp in the live stream of the video content within the time interval, wherein the beginning timestamp and ending timestamp define a length of the candidate short video.

Processing, by the multi-modal neural network system, the multi-modal input to generate the output may comprise: processing, by a live content data model included in the multi-modal neural network system, the multi-modal input to generate interaction data that characterizes interactions between the content creator and the content viewers; and processing, by a proposer neural network included in the multi-modal neural network system, the multi-modal input and the interaction data to generate the output that comprises the beginning timestamp and the ending timestamp.

Selecting the one or more short videos may comprise: for each time interval in the plurality of successive time intervals, processing, using a selector neural network, (i) the candidate short video generated for the time interval and (ii) a set of one or more content criteria to generate a rating score for each content criterion in the set that measures a degree to which the candidate short video satisfies the content criterion; and selecting the one or more short videos from the candidate short videos based on the rating scores.

Selecting the one or more short videos may comprise: for each time interval in the plurality of successive time intervals, processing, using a selector neural network, (i) the candidate short video generated for the time interval and (ii) the visual data and audio data included in the creator content stream to generate an importance score that represents a degree to which the candidate short video summarizes content of the creator content stream; and selecting the one or more short videos from the candidate short videos based on the importance scores.

Providing the one or more selected short videos for presentation may comprise providing the one or more selected short videos as part of a summary of the creator content stream that summarizes a view history of the creator content stream.

The method may further comprise: generating a final short video based on the selected short video; and storing the final short video in a database.

The creator content stream and the one or more viewer content streams may not be stored in the database.

According to another aspect, there is provided one or more computer-readable storage media encoded with instructions that, when executed by one or more computers, cause the one or more computers to perform the operations of the above method aspects.

According to a further aspect, there is provided a system comprising one or more computers and one or more storage devices storing instructions that when executed by one or more computers cause the one or more computers to perform the respective operations of the above method aspects.

The subject matter described in this specification can be implemented in particular embodiments so as to realize one or more of the following advantages. Short videos are more easily accessible to users than long videos. The described techniques allow for short videos to be generated based on long videos automatically and with minimal user involvement by making use of the described multi-modal neural network system and the described moving window techniques.

Unlike the described techniques, existing short video generation solutions typically involve an offline process that is performed after a video has been generated and then manually modified to a shorter length, requiring heavy human involvement. As a particular example, implementations of the described techniques can enable a video platform to automatically (i.e., without user involvement) and in real-time process a live stream of video content that includes multi-modal data associated with a live video feed to generate therefrom a short video that can be published immediately after the live video feed has ended.

Leveraging the multi-modal data (e.g., text data, graph data, etc.) beyond just the underlying live video feed itself, the video short generated by the video platform can more accurately reflect moments where the content viewers are engaged relative to existing short video generation solutions that do not operate on such multi-modal data.

The automatically generated short videos present a variety of technological advantages that were previously not possible with long videos. For one, short videos facilitate the storage of video data on the data processing apparatuses where memory resources are limited. For another, short videos, when distributed across client devices over a network, can reduce network bandwidth utilization than long videos. Further, compared to long videos, short videos can be more quickly indexed and made more searchable for users, thus increasing the value of the video data.

The automatically generated short videos allow users to preview the content of a long video, while avoiding consuming an excessive amount of computational power and wall clock time to watch and/or scan the entire long video. Thus, the described techniques provide a technical solution for users to more quickly find specific content from a large corpus of long videos. That is, when users are looking for a particular long video about a particular concept, rather than having to watch or scroll through multiple long videos in their entirety to locate the particular long video, the user may only watch the automatically generated short videos that summarize the respective content of the multiple long videos.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a video platform generates short videos based on live streams of video content.

FIG. 2 is an illustration of an example creator content stream and an example viewer content stream.

FIG. 3 is an illustration of example operations performed by a multi-modal neural network system.

FIG. 4 is a flow chart of an example process of generating a short video based on a live stream of video content.

FIG. 5 is an illustration of example user interface.

FIG. 6 a block diagram of an example computer.

Like reference numbers and designations in the various drawings indicate like elements.

### DETAILED DESCRIPTION

This specification describes techniques for automatically, i.e., with no or minimal user involvement, generating short videos from long videos. A short video includes one or more video frames selected from a plurality of video frames included in a corresponding, long video. In cases where the long video is a live video feed in which new video frames are continuously appended to the live video feed as they become available, using the described techniques can generate short videos in real-time as the live video feed is being obtained.

A multi-modal neural network system is used to process a live stream of video content that includes one or more data streams that are associated with the long video, e.g., the live video feed, to generate one or more short videos. For example, the live stream of video content can include a creator content stream that corresponds to a content creator that captures and broadcasts the live video feed, and one or more viewer content streams that each correspond to a respective content viewer that views the live video feed.

In particular, while the live video feed is being broadcasted, the multi-modal neural network system generates candidate short videos across a plurality of successive time intervals during the live stream of video content. One or more short videos can then be selected from the candidate short videos that have been generated.

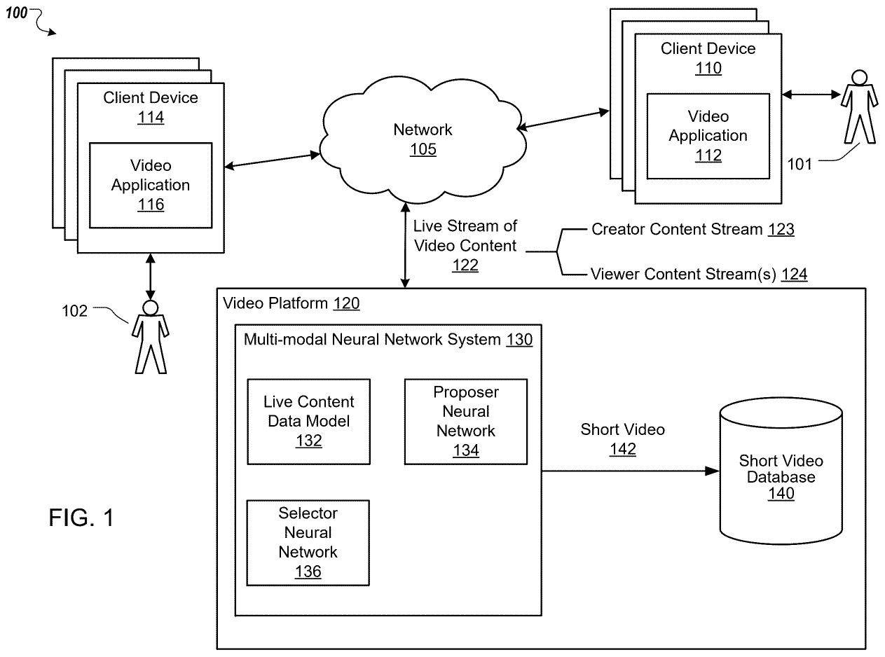

FIG. 1 is a block diagram of an example environment 100 in which a video platform 120 generates short videos 142 based on live streams of video content 122. The example environment 100 includes a data communication network 105, such as a local area network (LAN), a wide area network (WAN), the Internet, a mobile network, or a combination thereof. The network 105 connects client devices 110, 114 and the video platform 120. The example environment 100 can include many different client devices 110, 114 and video platforms 120.

A client device 110, 114 is an electronic device that is capable of communicating over the network 105. Example client devices 110, 114 include personal computers, gaming devices, mobile communication devices, e.g., smart phones, digital assistant devices, augmented reality devices, virtual reality devices, and other devices that can send and receive data over the network 105. A client device can also include a digital media device, e.g., a streaming device that plugs into a television or other display to stream videos to the television.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. The digital assistant can be implemented in different forms of hardware devices including, a wearable device (e.g., watch or glasses), a smart phone, a speaker device, a tablet device, or another hardware device. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

A client device 110, 114 typically includes applications, such as web browsers and/or native applications, to facilitate the sending and receiving of data over the network 105. A native application is an application developed for a particular platform or a particular device (e.g., mobile devices having a particular operating system).

The applications include a video application 112, 116 which can be a native application for processing videos, a web browser that processes videos of web pages, or another type of application capable of processing videos. For example, the video application 112, 116 can be a social networking application, video sharing application, video streaming application, video on demand application, video sharing application, chat application, mobile application of a content provider or any combination of such applications.

Video applications can facilitate the creation of content that includes videos. For example, in FIG. 1, the client device 110 corresponds to a user (a content creator) 101, and the video application 112 of the client device 110 can provide a user interface (e.g., a graphical user interface) to be rendered in a display of the client device 110 for capturing, editing, and/or uploading videos. The videos can be captured by using any appropriate video capture component, e.g., an onboard camera, of the client device 110.

Additionally, the video applications can render, display, and/or present content that includes videos. For example, in FIG. 1, the client device 114 corresponds to a user (a content viewer) 102, and the video application 116 of the client device 114 can provide a user interface (e.g., a graphical user interface) to be rendered in a display of the client device 114 for requesting, receiving and/or playing videos. The videos to be displayed on the client device 114 can include those created, edited, and/or uploaded by a content provider, e.g., the content creator 101 or another user.

The videos can include short videos, also known as “short-form videos.” A short video is a video with a duration less than a predetermined maximum duration (e.g., less than 5 minutes, less than 60 seconds, less than 30 seconds, or less than 15 seconds). The short videos can include those stored in a short video database 140.

The videos can also include long videos, also known as “long-form videos.” A long video is a video with a duration longer than the predetermined maximum duration (e.g., more than 5 minutes, more than 60 seconds, more than 30 seconds, or more than 15 seconds).

An example of long video is a live (continuous) video feed in which new video frames are continuously appended to the continuous video feed as they become available (e.g., as they are being recorded and being broadcast to one or more viewers over a network). A live video feed may last hours, days, and even weeks. A live video feed is commonly broadcasted to thousands, and potentially millions of content viewers concurrently. A live video feed may include any suitable type of video content, such as a live event, on-demand content, television programs, movies, or any other suitable types of video content.

For example, in FIG. 1, the content creator 101 can instruct the client device 110 to initiate a live video feed using an onboard camera—the live video feed can then be displayed on the display of the client device 110 that corresponds to the content creator 101, and can further be transmitted over the network 105 to be displayed on the display of the client device 114 that corresponds to the content viewer 102 (and on the displays of other client devices that correspond respectively to different content viewers).

While the live video feed is being broadcasted, the video platform 120 obtains a live stream of video content 122. The live stream of video content 122 includes a creator content stream 123 and one or more viewer content streams 124. The video platform 120 can obtain each of the creator content stream 123 and the one or more viewer content streams 124 as individual data streams (in parallel with the live stream) that are continuously generated over time from the same or different sources.

In some implementations, as the content creator 101 captures and uploads a live video stream, the video application 112 in the client device 110 continuously generates a creator content stream 123, insofar as the live video stream has not ended, and continuously transmits the creator content stream 123 as a data stream over the network 105 to the video platform 120.

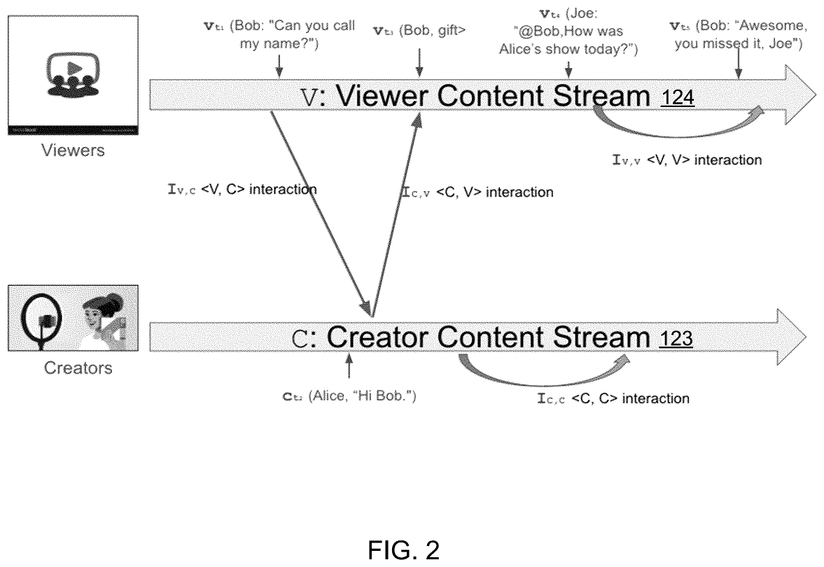

Analogously, as the content viewer 102 views the live video stream, the video application 116 in the client device 114 continuously generates a viewer content stream 124, insofar as the live video stream has not ended, and continuously transmits the viewer content stream 124 as a data stream over the network 105 to the video platform 120. The creator and viewer content streams are further described with reference to FIG. 2.

In some other implementations, the video platform 120 receives these data streams from a common source, e.g., another video streaming service provider, where each data stream is associated with metadata that identifies the content of the data stream, or the type or modality of data included in the data stream.

FIG. 2 is an illustration of an example creator content stream 123 and an example viewer content stream 124. The creator content stream 123 corresponds to a content creator, e.g., the content creator 101. The viewer content stream 124 corresponds to a content viewer, e.g., the content viewer 102.

The creator content stream 123 includes the live video feed that can be provided by the video application 112 in the client device 110 that corresponds to the content creator 101. The live video feed includes visual data and audio data. The visual data can include video frames where each video frame is an image that includes pixels. The audio data can include audio frames that correspond to sounds or speech uttered by the content creator 101 and/or other sounds included by the content creator 101 in the live video stream.

The video and audio frames can be aligned with timestamps. In some implementations, the time alignment is relative to an initial time location at which the live stream of video content 122 begins. That is, the time alignment of the video and audio frames uses the initial time location as a reference.

For example, when live video feed is about a live event that involves the content creator 101, the visual data can include video frames that depict the content creator 101, and the audio data can include audio frames that characterize speech uttered by the content creator 101.

Optionally, the creator content stream 123 also includes creator action data that characterizes actions performed by the content creator 101 while creating the live video feed included in the creator content stream. The creator action data can be represented as text data and aligned with timestamps in order to be accurately associated with the visual data and/or audio data included in the creator content stream 123. In some implementations, the time alignment of the creator action data uses the same reference as the video and audio frames.

Examples of actions that can be performed by the content creator 101 include the creation of a chat session to be presented together with (e.g., beside) the displayed visual data, e.g., “Hi Bob”, the creation of a poll or vote to be presented together with (e.g., beside) the displayed visual data, and the creation of a sticker to be overlaid onto the displayed visual data, and so forth.

Each viewer content stream 124 includes viewer action data that characterizes actions performed by a corresponding content viewer, e.g., the content viewer 102, while observing the live video feed included in the creator content stream 123. Like the creator action data, the viewer action data can be represented as text data and aligned with timestamps in order to be accurately associated with the visual data and/or audio data included in the creator content stream 123. In some implementations, the time alignment of the viewer action data uses the same reference as the video and audio frames.

Examples of actions that can be performed by the content viewer 102 include the participation of a chat session with the content creator 101 (e.g., posting a conversational turn, e.g., “can you call my name?”), the participation of a chat session with other content viewers (e.g., posting a conversational turn, e.g., “Bob, how was Alice's show today?” “Awesome, you missed it, Joe”, the participation of a poll or vote (e.g., submitting +1, like, dislike, etc.), gifting, e.g., “gift”, and so forth. In general, because different content viewers might perform different actions while observing the same live video feed, each viewer content streams will likely include different viewer action data.

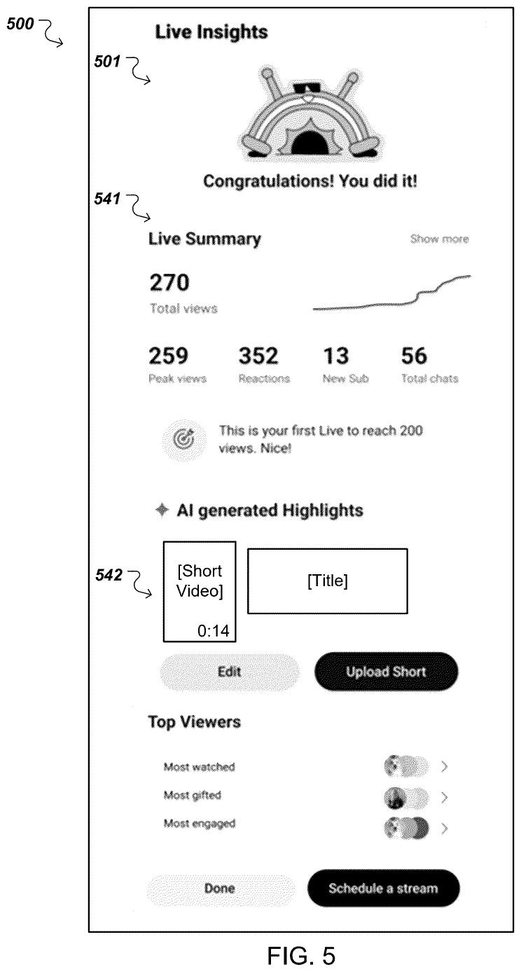

The video platform 120 includes a multi-modal neural network system 130 that can be implemented using one or more computer systems, e.g., the computer system 500 of FIG. 5. Although FIG. 1 shows the multi-modal neural network system 130 as part of the video platform 120, in various implementations, the multi-modal neural network system 130 can be part of a separate computer system and/or operated by a different party than the video platform 120.

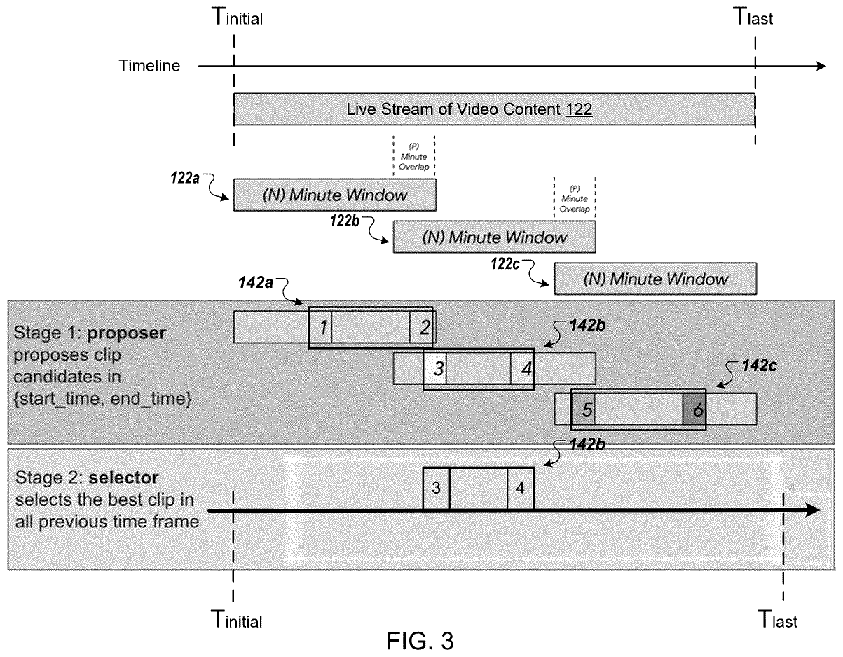

The multi-modal neural network system 130 includes a live content data model 132, a proposer neural network 134, and, in some implementations, a selector neural network 136, which are further described with reference to FIG. 3.

FIG. 3 is an illustration of example operations performed by the multi-modal neural network system 130 of FIG. 1 to generate candidate short videos across a plurality of successive time intervals during the live stream of video content 122 by using a moving window technique, and select one or more short videos from the candidate short videos that have been generated.

In some implementations, the plurality of successive time intervals can each have about equal length. For example, the live stream of video content 122 can be divided into successive time intervals (e.g., 10, 20, or 30 second intervals) based at least in part on applying a moving window that has a fixed time length and moves across a temporal dimension of the live stream of video content 122 at fixed step sizes. The moving window over the temporal dimension of the live stream of video content 122 can select the portion of the live stream of video content 122 to be included in each time interval.

In some implementations, the plurality of successive time intervals can be nonoverlapping. For example, a given video (or audio) frame may be included within only one time interval of the plurality of successive time intervals. In other implementations, the plurality of successive time intervals can at least partly overlap with each other. For example, a given video (or audio) frame may be included within two successive time intervals of the plurality of successive time intervals.

A timeline for the live stream of video content 122 that includes time locations for the live stream of video content 122 is illustrated in FIG. 3. The live stream of video content 122 begins from the initial time location and ends at the last time location.

In the example of FIG. 3, the live stream of video content 122 include time intervals 122a, 122b, and 122c, where each time interval corresponds to a time window that spans N units of time (e.g., minutes). N can be any positive number. The time intervals 122a, 122b, and 122c at least partly overlap with each other. The overlap spans P units of time (e.g., minutes). P can be any positive number that is smaller than N.

The live content data model 132 is configured to, for each time interval in the plurality of successive time intervals during the live stream of the video content 122, receive a multi-modal input and process the multi-modal input to generate interaction data that characterizes interactions between the content creator and the one or more content viewers during the time interval.

In general, a multi-modal input for each time interval is an input that includes multi-modal data, i.e., that includes a combination of two or more different types of data, e.g., two or more of audio data, visual data, text data, or graph data.

More specifically, the multi-modal input for a particular time interval includes a portion of the creator content stream 123 that corresponds to that time interval. That is, the multi-modal input includes the video and audio frames from the creator content stream 123 within the particular time interval.

When the creator content stream 123 also includes the creator action data, the multi-modal input also includes a portion of the creator action data included in the creator content stream 123 that corresponds to the time interval. That is, the multi-modal input also includes a portion of the creator action data that characterizes actions performed by the content creator 101 within the time interval.

The multi-modal input includes, for each viewer content stream 124, a portion of the viewer action data included in the viewer content stream 124 that corresponds to the time interval. That is, the multi-modal input includes a portion of the viewer action data that characterizes actions performed by the content viewer 102 within the time interval.

For example, in FIG. 3, the live content data model 132 is configured to, for time interval 122a, receive a multi-modal input that includes at least (i) the video and audio frames from the creator content stream 123 within the time interval 122a, (ii) a portion of the creator action data that characterizes actions performed by the content creator 101 within the time interval 122a, and (iii) for each viewer content stream, a portion of the viewer action data that characterizes actions performed by the content viewer corresponding to the viewer content stream within the time interval 122a.

In some implementations, the multi-modal input also includes historic interaction data that characterizes historical interactions between the content creator and the one or more content viewers during one or more preceding time intervals during the live stream of the video content 122.

In some implementations, the multi-modal input also includes a text transcription of the speech uttered by the content creator 101 or other individuals within the time interval. Examples of speech include spoken dialogue, narration, and/or sung song lyrics. For example, the text transcription can be generated by processing the audio and, optionally, the video frames from the creator content stream 123 within the time interval using an automatic speech recognition (ASR) model.

The ASR model can be implemented any of a variety of ways. For example, the ASR model can implement a speech recognition neural network, e.g., a recurrent neural network or an attention neural network, or another machine learning model, which has been trained on training data including audio data with corresponding transcriptions. As another example, the ASR model can implement a statistical speech recognition model, e.g., a Hidden Markov model (HMM) or a dynamic time warping (DTW) model.

In some implementations, the multi-modal input also includes metadata associated with the live stream of video content 122 that is obtained by the video platform 120. Examples of the metadata include: a downsampling rate of the video frames included in the creator content stream 123 when being uploaded by the client device 110, a frame rate of the video frames included in the creator content stream 123 when being displayed at the client device 114, a total number of video frames included in the creator content stream 123, a pixel resolution or pixel values within each video frame, and so forth.

For each time interval in the plurality of successive time intervals during the live stream of the video content 122, the interaction data that is generated by the live content data model 132 from processing the multi-modal input can characterize any of a variety of types of interactions by and/or between the content creator and the one or more content viewers during the time interval.

For example, as illustrated in FIG. 2, the interaction data can include a first type of interaction data I_{V,C}:V×C (where V represents content viewer, and C represents content creator), which characterizes a first type of interactions: reciprocal actions performed by the content creator 101 in response to actions performed by the content viewer 102.

Examples of the first type of interactions include: the content creator 101 responding to a question posted by the content viewer 102 in a chat session, the content creator 101 sending an appreciation to the content viewer 102 who donated a gift, the content creator 101 extending the live video feed with warm audiences, and the content creator 101 stopping the live video feed with too many trolls/spammers or no audience.

As another example, as illustrated in FIG. 2, the interaction data can include a second type of interaction data I_{C,V}:C×V, which characterizes a second type of interactions: reciprocal actions performed by the content viewer 102 in response to actions performed by the content creator 101.

Examples of the second type of interactions include: the content viewer 102 responding in text (e.g., via chat) or as a speech utterance in the video stream, to a question posted by the content creator 101, the content viewer 102 participating in a poll or vote created by the content creator 101, and the content viewer 102 donating a gift to the content creator 101.

As another example, as illustrated in FIG. 2, the interaction data can include a third type of interaction data I_{V,V}:V×V, which characterizes a third type of interactions: reciprocal actions performed by one of the content viewers 102 in response to actions performed by another one of the content viewers 102.

That is, the interaction data can include a third type of interaction data which characterizes interactions between the one or more content viewers themselves. Examples of the third type of interactions include: the content viewer 102 posting a comment in a chat session that is a response to a previous comment posted by another content viewer, and the content viewer 102 responding to a question posted by another content viewer.

As another example, as illustrated in FIG. 2, the interaction data can include a fourth type of interaction data I_{V,V}:C×C, which characterizes a fourth type of interactions: reciprocal actions performed by the content creator 101 in response to actions performed by another content creator (that is broadcasting another live video feed).

That is, the interaction data can include a fourth type of interaction data which characterizes interactions between the one or more content creators themselves. Examples of the fourth type of interactions include the content creator 101 cooperating with or competing against another content creator that are both creating live video feeds concurrently.

Such interaction data can be modeled as any data structure that can be generated by using the live content data model 132. Examples of the data structures that are suitable for characterizing the interactions between the content creator and the one or more content viewers during the time interval include: a list, an array, a queue, a table, a graph, and so forth.

As a particular example, the interaction data can be modeled as a dynamic temporal graph. The dynamic temporal graph can be a multipartite graph that includes nodes that can be grouped into multiple types, and edges between the nodes. The multiple types of nodes include: a first type of nodes (content creator nodes) representing content creators and a second type of nodes (content viewer nodes) representing content viewers. Each interaction is shown in the dynamic temporal graph as an edge. Each edge is a line between two nodes, where the nodes represent participants of the interaction.

Each edge in the dynamic temporal graph is associated with a feature vector having numeric values that represent the features of the interaction that is represented by the edge. Example features of the interaction can include: a type of the interaction, a timestamp of the interaction, a length of the interaction, a frequency of the interaction, and/or any other suitable information associated with the interaction.

In this particular example, the live content data model 132 can, for each time interval in the plurality of successive time intervals during the live stream of the video content 122, process the multi-modal input to update a dynamic temporal graph, i.e., to generate an updated dynamic temporal graph. The updated dynamic temporal graph represents the interaction data that characterizes interactions between the content creator and the one or more content viewers during the time interval.

The dynamic temporal graph that is updated in this way across the plurality of successive time intervals has two key properties. Firstly, the dynamic temporal graph is temporal, as every edge has an associated time (i.e., the timestamp of the interaction). Secondly, the dynamic temporal graph is dynamic and evolves over time, such that additional nodes and/or edges are added to the dynamic temporal graph when additional interactions occur.

The live content data model 132 can have any appropriate neural network architecture that enables it to perform its described function, i.e., to receive a multi-modal input and process the multi-modal input to generate interaction data. For example, the live content data model 132 can include any appropriate types of neural network layers (e.g., fully-connected layers, attention-layers, convolutional layers, graph neural network layers, etc.) in any appropriate numbers (e.g., 5 layers, 10 layers, or 25 layers), and connected in any appropriate configuration (e.g., as a linear sequence of layers).

The proposer neural network 134 is configured to, for each time interval in the plurality of successive time intervals during the live stream of the video content 122, process the interaction data and, optionally, the multi-modal input, to generate an output that identifies the candidate short video.

The candidate short video includes a proper subset of video frames selected from the video frames included in the creator content stream 123 within the time interval, and a proper subset of audio frames selected from audio frames included in the creator content stream 123 within the time interval. A proper subset includes at least one video (or audio) frame, but less than all of the video (or audio) frames in the creator content stream 123 within the time interval.

In particular, the proposer neural network 134 selects a relatively small number of video (and audio) frames from all of the video (and audio) frames in the creator content stream 123 within each time interval in the plurality of successive time intervals.

While each time interval within the creator content stream 123 may include a large number of, e.g., ten thousand, one hundred thousand, or more, video (and audio) frames, only a small portion of them may actually be selected, e.g., only twenty, fifty, or one hundred video (and audio) frames may be selected for inclusion in a candidate short video.

In some implementations, the output includes a beginning timestamp and an ending timestamp that define a length of the candidate short video. The beginning or the ending timestamp can be represented either absolutely, e.g., in “hour:minute:second” format, or relatively, e.g., relative to the initial timestamp of the live stream of video content.

For example, FIG. 3 illustrates that, for time interval 122a, the proposer neural network 134 generates an output that includes a beginning timestamp T1 and an ending timestamp T2 that define a length of a candidate short video 142a that corresponds to the time interval 122a. For time interval 122b, the proposer neural network 134 generates an output that includes a beginning timestamp T3 and an ending timestamp T4 that together define a length of a candidate short video 142b that corresponds to the time interval 122b. For time interval 122c, the proposer neural network 134 generates an output that includes a beginning timestamp T5 and an ending timestamp T6 that define a length of a candidate short video 142c that corresponds to the time interval 122c.

Because multiple candidate short videos have been generated across the plurality of successive time intervals during the live stream of video content 122, the video platform 120 can determine which one(s) of the multiple candidate short videos to provide as the one or more short videos 142 in response to the live stream of video content 122. Such a determination can be made in many different ways.

When the selector neural network 136 is not included in the multi-modal neural network system 130, the video platform 120 can make this determination by randomly selecting one or more of multiple generated candidate short videos, or selecting one or more most recently generated candidate short videos (e.g., the candidate short video generated for the latest time interval in the plurality of successive time intervals during the live stream of the video content 122), for example.

Alternatively, when the selector neural network 136 is included, the video platform 120 can use it to select, from the candidate short videos that have been generated across the plurality of successive time intervals, the one or more short videos 142. For example, FIG. 3 illustrates that the selector neural network 136 selects the candidate short video 142b from the total of three candidate short videos 142a-142c generated respectively for three time intervals 122a-122c.

In some implementations, the selector neural network 136 is configured to, for each time interval in the plurality of successive time intervals during the live stream of the video content 122, process (i) the candidate short video generated for the time interval and (ii) the live video feed included in the creator content stream 123 to generate an importance score for the candidate short video. As mentioned previously the live video feed includes visual and audio data.

The importance score represents a degree to which the candidate short video summarizes, i.e., represents the most important or interesting content within, the live video feed included in the creator content stream 123.

In these implementations, the video platform 120 thereafter selects the one or more short videos 142 using the importance scores. For example, the video platform 120 can select one or more short videos 142 that have the highest importance scores among the candidate short videos generated for the plurality of successive time intervals. As another example, the video platform 120 can select one or more short videos 142 that each have an importance score that is greater than an importance threshold.

In some implementations, the video platform 120 maintains data specifying a set of one or more content criteria, and the selector neural network 136 is configured to, for each time interval in the plurality of successive time intervals during the live stream of the video content 122, process (i) the candidate short video generated for the time interval and (ii) the set of one or more content criteria to generate a rating score of the candidate short video for each content criterion in the set.

The rating score for a content criterion measures the degree to which the candidate short video satisfies the criterion. The set of one or more content criteria can include any of a variety of content criteria that measures a corresponding property of a candidate short video.

For example, the set of one or more content criteria can include a criterion that corresponds to the consumability of the candidate short video. The consumability criterion measures whether the candidate short video summarizes the content of the live video feed well. For example, the consumability criterion can measure whether the first 5 seconds of the candidate short video delivers a clear expectation on what the live video feed will be about.

As another example, the set of one or more content criteria can include a criterion that corresponds to the storytelling of the candidate short video. The storytelling criterion measures whether the candidate short video is clear, coherent, and easy to follow by a content viewer. For example, the storytelling criterion can measure whether the content of the candidate short video can be easily understood by a content viewer.

As another example, the set of one or more content criteria can include a criterion that corresponds to the emotion of the candidate short video. The emotion criterion measures whether the candidate short video resonates with the emotional/unique appeal of a content creator. For example, the emotion criterion can measure whether the candidate short video shows a personality or emotional response of the content creator that content viewers can resonate to.

Other content criteria can be included instead of or in addition to the above content criteria. For example, the other content criteria can include a suitability criterion that measures the degree to which a candidate short video is suitable for being provided in response to the live streams of video content 122.

Once the rating scores are generated, the video platform 120 can determine which one(s) of the multiple candidate short videos to provide in response to the live stream of video content 122 by using the rating scores in any of a variety of ways.

In some implementations, the video platform 120 generates, for each candidate short video, a quality score from the rating scores for the candidate short video for the one or more content criteria in the set. The quality score represents an overall quality of the candidate short video as measured by the set of one or more content criteria.

For example, the quality score for a candidate short video can be a sum or a weighted sum of the rating scores for the one or more content criteria. The video platform 120 can then select one or more short videos 142 that have the highest quality scores among the candidate short videos.

The proposer neural network 134 and the selector neural network 136 can each have any appropriate neural network architecture that enable them to perform their respective described functions. For example, the proposer neural network 134 and the selector neural network 136 can each include any appropriate types of neural network layers (e.g., fully-connected layers, attention-layers, convolutional layers, etc.) in any appropriate numbers (e.g., 5 layers, 10 layers, or 25 layers), and connected in any appropriate configuration (e.g., as a linear sequence of layers).

In some implementations, the proposer neural network 134 and the selector neural network 136 can each have a Transformer-based neural network architecture that allows the model to map an input sequence of tokens from a vocabulary to an output sequence of tokens from the vocabulary.

In some of these implementations, the proposer neural network 134 and the selector neural network 136 can each be a multi-modal neural network, and the tokens in the vocabulary can include text tokens representing text symbols or other symbols, as well as tokens representing one or more other data modalities, e.g., images, videos, or audio.

Examples of text tokens include: characters, sub-words, words, punctuation marks, numbers, or other symbols that appear in a corpus of natural language text and/or computer code. Examples of tokens that represent another data modality include: image tokens that represent a discrete set of image patch embeddings of an image that can be generated by an image encoder neural network based on processing the image patches of the image, audio tokens that represent code vectors in a codebook of a quantizer, e.g., a residual vector quantizer, and so forth.

In general a Transformer-based neural network architecture can be one which is characterized by having a succession of self-attention neural network layers. A self-attention neural network layer has an attention layer input for each element of the input and is configured to apply an attention mechanism over the attention layer input to generate an attention layer output for each element of the input. There are many different attention mechanisms that may be used.

Examples of Transformer-based, multi-modal neural network architectures include those described in Driess, Danny, et al. PaLM-E: An Embodied Multimodal Language Model. arXiv preprint arXiv:2303.03378(2023); Gemini Team, et al. Gemini: a family of highly capable multimodal models. arXiv preprint arXiv:2312.11805(2023); and Gemini Team, et al., Gemini 1.5: Unlocking multimodal understanding across millions of tokens of context. arXiv preprint arXiv:2403.05530 (2024).

Although the proposer neural network 134 and the selector neural network 136 are illustrated as separate components in FIG. 1, in some implementations, the two of them can be implemented as a single component of the multi-modal neural network system 130. That is, in some implementations, the same multi-modal neural network can function as both the proposer neural network 134 and the selector neural network 136.

Thus, the multi-modal neural network system 130 uses the same multi-modal neural network both as a “proposer” to “propose,” i.e., generate, multiple candidate short videos across the plurality of successive time intervals and a “selector” to select one or more of the multiple candidate short videos to provide in response to the live stream of video content 122.

When trained at sufficient scale, a multi-modal neural network, e.g., a multi-modal neural network that has a Transformer-based neural network architecture, can be made to perform a particular task by providing a natural language description of the particular task as an input or “prompt.” To leverage the ability of the multi-modal neural network to perform new tasks on which it may not be explicitly trained, the prompt may be a few-shot prompt where a few, e.g., 1 to 10, examples of an input and an output are provided in the text prior to the actual query.

For example, the prompt for causing the multi-modal neural network to function as the proposer neural network 134 can be: “You are an intelligent chatbot designed for identifying interesting/important content given a video stream, a sequence of textual summaries describing the video stream, or both. Use your judgment to analyze [the multi-modal input] and propose beginning and ending timestamps for the most interesting/important event in the video stream. The timestamp is denoted in <hour:minute:second>format.”

As another example, the prompt for causing the multi-modal neural network to function as the selector neural network 136 can be: “You are an intelligent chatbot designed for evaluating short videos for their importance or interestingness within a long video. Use your judgment to analyze [the multiple candidate short videos] to select one or more of them that are most important or interesting within the long video.” or “You are an intelligent chatbot designed for evaluating short videos for their qualities according to [the set of one or more content criteria]. Use your judgment to analyze [the multiple candidate short videos] to evaluate their qualities according to [the set of one or more content criteria]. For each candidate short video, the evaluation result for each content criteria is represented in a numeric score between 0 and 1.”

Once the one or more short videos 142 are selected from the multiple candidate short videos have been generated across the plurality of successive time intervals during the live stream of video content 122, the video platform 120 can provide the one or more short videos 142 to a client device for presentation or for some immediate purpose.

In some implementations, the video platform 120 can provide the one or more short videos 142 for presentation in a user interface of a client device, e.g., the user interface of the video application 112 of the client device 110 that corresponds to the content creator 101.

For example, at the end of the live video feed, an end card can be presented to the content creator 101. The end card includes a summary of the live video feed that summarizes a view history of the live video feed, e.g., the total number of content viewers of the live video feed, the total time length of the live video feed, the total value of gifts donated by the content viewers, and so forth. The one or more short videos 142 can then be presented for display to the content creator 101 in association with the summary.

In some implementations, the video platform 120 can use a short video 142 as a thumbnail of video content to be displayed prior to the playback of the live video feed to inform a content viewer of the content of the live video feed that will be displayed. In some implementations, the video platform 120 can include use a short video 142 as part of user profile data associated with the content creator 101.

In some implementations, the video platform 120 can provide the candidate short videos for display on client devices while the broadcasting is still ongoing, such that the candidate short videos can serve as a recapitulation of the past content of the live video feed to draw in an audience to an ongoing live streaming event. That is, the video platform 120 can provide the content viewers of a live video feed with an enhanced user experience using the automatically generated candidate short videos.

Additionally or alternatively, the video platform 120 can provide the one or more short videos 142 to another system for further processing, or store the one or more short videos 142 in a storage device for some future purpose.

In some implementations, the video platform 120 can store the one or more short videos 142 in a short video database 140. The short video database 140 can be implemented on one or more storage devices, e.g., one or more hard drives, flash memory, etc., that is accessible by the video platform 120.

In some of these implementations, the short videos 142 are stored in the short video database 140 as-is once they are generated by the video platform 120. In others of these implementations, the short videos 142 can be modified, e.g., edited by the content creator 101, and the modified short videos 142 will then be stored in the short video database 140, either in addition to or in place of the short videos 142.

For example, the video platform 120 can provide the one or more short videos 142 for presentation in the user interface of the video application 112 of the client device 110—and the content creator 101 can generate a final short video based on the one or more short videos 142 by truncating or concatenating the content of the one or more short videos 142, adding visual and/or sound effects to the one or more short videos 142, inserting and/or appending additional video and/or audio frames that are currently not included, and/or adjusting another aspect of the one or more short videos 142. The final short video will then be stored in the short video database 140 in place of the one or more short videos 142.

The short video database 140 may be configured to store exclusively short videos. That is, no long videos are stored in the short video database 140. For example, none of the live video feeds will be stored in the short video database 140, and the visual and audio data included in the live video feeds may be discarded once they have ended. In this way, the memory footprint of the video platform 120 is reduced to provide storage space savings, such that the video platform 120 can be more practically deployed on data processing apparatuses where memory resources are limited.

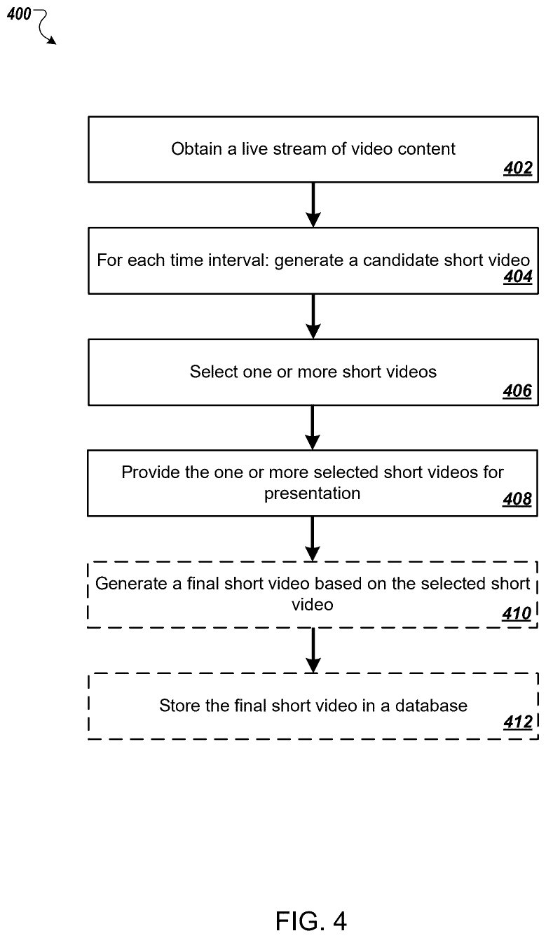

FIG. 4 is a flow chart of an example process 400 of generating a short video based on a live stream of video content. Operations of the process 400 can be performed, for example, by the video platform 120 of FIG. 1, or another data processing apparatus. The operations of the process 400 can also be implemented as instructions stored on a computer readable medium, which can be non-transitory. Execution of the instructions, by one or more data processing apparatus, causes the one or more data processing apparatus to perform operations of the process 400.

The video platform obtains a live stream of video content (402). The live stream of video content can be obtained while a live video feed is being captured by (using a video capture component of) a client device that corresponds to a content creator and broadcasted over a network to one or more client devices that correspond respectively to one or more content viewers.

The live stream of video content includes a creator content stream. In some implementations, the creator content stream can be obtained from the client device that corresponds to the content creator. The creator content stream includes the live video feed. The live video feed includes visual data and audio data. The visual data can include video frames where each video frame is an image that includes pixels. The audio data can include audio frames that characterize speech in the live video stream. Optionally, the creator content stream also includes creator action data that characterizes actions performed by the content creator while creating the live video feed.

The live stream of video content includes one or more viewer content streams. In some implementations, each viewer content stream can be obtained from a client device that corresponds to a content viewer. Each viewer content stream includes viewer action data that characterizes actions performed by a content viewer while observing the live video feed provided by the content creator.

For each time interval in a plurality of successive time intervals during the live stream of the video content, the video platform generates a candidate short video based on using a multi-modal neural network system (404). The candidate short video includes a proper subset of video frames selected from the video frames included in the creator content stream within the time interval, and a proper subset of audio frames selected from audio frames included in the creator content stream within the time interval.

The multi-modal neural network system includes a live content data model and a proposer neural network.

The live content data model is configured to, for each time interval, process a multi-modal input for the time interval that includes (i) a portion of the creator content stream that corresponds to the time interval and (ii) for each viewer content stream, a portion of the viewer action data included in the viewer content stream that corresponds to the time interval, to generate interaction data corresponding to the time interval. The interaction data characterizes interactions between the content creator and the content viewers within the time interval.

Optionally, the multi-modal input for the time interval also includes a portion of the creator action data included in the creator content stream that corresponds to the time interval.

Optionally, the multi-modal input for the time interval also includes historic interaction data corresponding to the one or more preceding time intervals that characterizes historical interactions between the content creator and the one or more content viewers during the one or more preceding time intervals.

Optionally, the multi-modal input for the time interval also includes a text transcription of the speech uttered by the content creator or other individuals within the time interval.

Optionally, the multi-modal input for the time interval also includes metadata associated with the live stream of video content that is obtained by the video platform.

The proposer neural network is configured to, for each time interval, process the interaction data and, optionally, the multi-modal input, to generate an output that identifies the candidate short video. In some implementations, the output includes a beginning timestamp and an ending timestamp that define a length of the candidate short video.

The video platform selects one or more short videos from the candidate short videos generated for the plurality of successive time intervals during the live stream of the video content (406). This selection can be made in many different ways. A few examples of how the video platform can make this selection are described above.

In general this selection can be made at any time point. In some implementations, the video platform can select the one or more short videos automatically and immediately after the live stream of the video content has ended. In other implementations, the video platform can select the one or more short videos while the live stream of the video content is still ongoing, for example, after a particular one of the plurality of successive time intervals during the live stream of the video content. In yet other implementations, the video platform can select the one or more short videos when a request or some other trigger signal is received.

The video platform provides the one or more selected short videos for presentation to the client device that corresponds to the content creator and, optionally, to the one or more client devices that correspond respectively to the one or more content viewers (408).

Optionally, the video platform generates a final short video based on the one or more selected short videos (410). For example, the video platform can provide the one or more selected short videos for presentation on the client device that corresponds to the content creator, and thereafter generate the final short video that incorporates any modifications, e.g., edits, that the content creator might make to the one or more selected short videos.

Optionally, the video platform stores the final short video in a database (412). In some implementations, the database can be a short video database configured to store exclusively short videos and rather than long videos, e.g., rather than the live video feed that is being broadcasted.

FIG. 5 is an illustration of example user interface 500. For example, the user interface 500 can correspond to a graphical user interface of the video application 112 of FIG. 1 of the client device 110 that corresponds to the content creator 101.

As illustrated in FIG. 5, at the end of a live video feed, an end card 501 is presented to the content creator 101 within the user interface 500. The end card 501 includes a summary 541 of the live video feed that summarizes a view history of the live video feed, such as total views, peak views, reactions, new subscriptions, total chats, top viewers, etc.

In addition to the summary 541, the end card 501 includes window in which a short video 542 is displayed. The short video 542 can have been generated by a video platform by performing an iteration of the process 400 of FIG. 4 based on a live stream of video content that is obtained while the live video feed is being broadcasted.

In the example of FIG. 5, the short video 542 is 14 seconds in length. The short video 542 includes highlight moments within the live video feed. In contrast, the live video feed might last several minutes, and even several hours. The user interface 500 provides an “edit” button and an “upload short” button.

The edit button is used to initiate an editing operation on the short video 542. That is, when the edit button is selected, the video application 112 might provide a set of editing tools to allow the content creator 101 to edit the short video 542. Different from the edit button, the upload short is for uploading the short video 542, either as-is or after being edited using the set of editing tools by the content creator 101, for storage in a short video database.

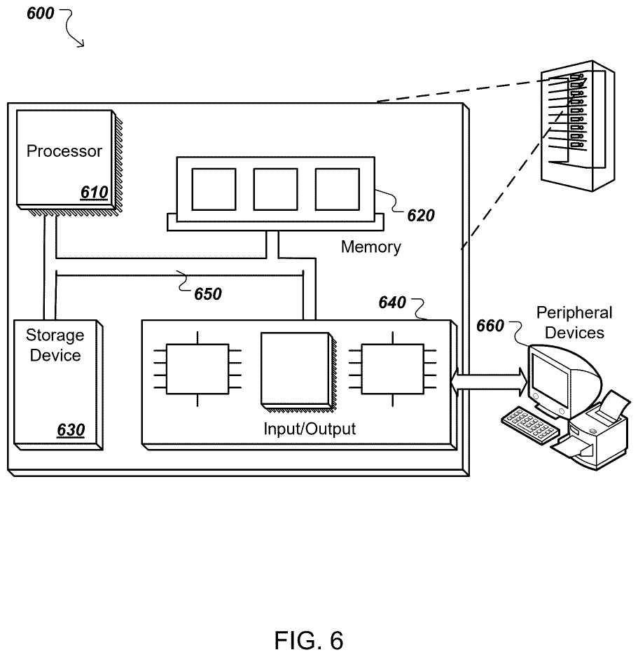

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining a live stream of video content that comprises a creator content stream and one or more viewer content streams, wherein the creator content stream comprises visual data and audio data provided by a content creator, and wherein each viewer content stream comprises action data that characterizes actions performed by a content viewer while observing the visual data and audio data provided by the content creator;
for each time interval in a plurality of successive time intervals during the live stream of the video content:
generating a candidate short video using a multi-modal neural network system to process a multi-modal input that comprises (i) a portion of the creator content stream that corresponds to the time interval and (ii) for each viewer content stream, a portion of the action data that characterizes actions performed by the content viewer within the time interval, wherein the candidate short video comprises a subset of video frames selected from video frames included in the creator content stream within the time interval and a subset of audio frames selected from audio frames included in the creator content stream within the time interval;
selecting, from the candidate short videos generated for the plurality of successive time intervals during the live stream of the video content, one or more short videos; and
providing the one or more selected short videos for presentation to the content creator.

2. The method of claim 1, wherein the multi-modal input comprises a text transcription of the speech uttered by the content creator, and wherein the method comprises processing the audio data using an automatic speech recognition (ASR) model to generate the text transcription.

3. The method of claim 1, wherein each creator content stream comprises action data that characterizes actions performed by the content creator while creating the visual data and audio data.

4. The method of claim 1, wherein the multi-modal input comprises metadata associated with the live stream of video content, and wherein the method comprises obtaining the metadata that comprise one or more of:
a downsampling rate of the video frames when being uploaded, or
a frame rate of the video frames when being displayed.

5. The method of claim 1, wherein generating the candidate short video based on using the multi-modal neural network system comprises:
processing, by the multi-modal neural network system and for each time interval in the plurality of successive time intervals, the multi-modal input to generate an output that comprises a beginning timestamp and an ending timestamp in the live stream of the video content within the time interval, wherein the beginning timestamp and ending timestamp define a length of the candidate short video.

6. The method of claim 5, wherein processing, by the multi-modal neural network system, the multi-modal input to generate the output comprises:
processing, by a live content data model included in the multi-modal neural network system, the multi-modal input to generate interaction data that characterizes interactions between the content creator and the content viewers; and
processing, by a proposer neural network included in the multi-modal neural network system, the multi-modal input and the interaction data to generate the output that comprises the beginning timestamp and the ending timestamp.

7. The method of claim 1, wherein selecting the one or more short videos comprises:
for each time interval in the plurality of successive time intervals, processing, using a selector neural network, (i) the candidate short video generated for the time interval and (ii) a set of one or more content criteria to generate a rating score for each content criterion in the set that measures a degree to which the candidate short video satisfies the content criterion; and
selecting the one or more short videos from the candidate short videos based on the rating scores.

8. The method of claim 1, wherein selecting the one or more short videos comprises:
for each time interval in the plurality of successive time intervals, processing, using a selector neural network, (i) the candidate short video generated for the time interval and (ii) the visual data and audio data included in the creator content stream to generate an importance score that represents a degree to which the candidate short video summarizes content of the creator content stream; and
selecting the one or more short videos from the candidate short videos based on the importance scores.

9. The method of claim 1, wherein providing the one or more selected short videos for presentation comprises providing the one or more selected short videos as part of a summary of the creator content stream that summarizes a view history of the creator content stream.

10. The method of claim 1, further comprising:
generating a final short video based on the selected short video; and
storing the final short video in a database.

11. The method of claim 10, wherein the creator content stream and the one or more viewer content streams are not stored in the database.

12. A system comprising:
one or more computers; and
one or more storage devices storing instructions that, when executed by the one or more computers, cause the one or more computers to perform operations comprising:
obtaining a live stream of video content that comprises a creator content stream and one or more viewer content streams, wherein the creator content stream comprises visual data and audio data provided by a content creator, and wherein each viewer content stream comprises action data that characterizes actions performed by a content viewer while observing the visual data and audio data provided by the content creator;
for each time interval in a plurality of successive time intervals during the live stream of the video content:
generating a candidate short video using a multi-modal neural network system to process a multi-modal input that comprises (i) a portion of the creator content stream that corresponds to the time interval and (ii) for each viewer content stream, a portion of the action data that characterizes actions performed by the content viewer within the time interval, wherein the candidate short video comprises a subset of video frames selected from video frames included in the creator content stream within the time interval and a subset of audio frames selected from audio frames included in the creator content stream within the time interval;
selecting, from the candidate short videos generated for the plurality of successive time intervals during the live stream of the video content, one or more short videos; and
providing the one or more selected short videos for presentation to the content creator.

13. The system of claim 12, wherein the multi-modal input comprises a text transcription of the speech uttered by the content creator, and wherein the method comprises processing the audio data using an automatic speech recognition (ASR) model to generate the text transcription.

14. The system of claim 12, wherein each creator content stream comprises action data that characterizes actions performed by the content creator while creating the visual data and audio data.

15. The system of claim 12, wherein the multi-modal input comprises metadata associated with the live stream of video content, and wherein the method comprises obtaining the metadata that comprise one or more of:
a downsampling rate of the video frames when being uploaded, or
a frame rate of the video frames when being displayed.

16. The system of claim 12, wherein generating the candidate short video based on using the multi-modal neural network system comprises:
processing, by the multi-modal neural network system and for each time interval in the plurality of successive time intervals, the multi-modal input to generate an output that comprises a beginning timestamp and an ending timestamp in the live stream of the video content within the time interval, wherein the beginning timestamp and ending timestamp define a length of the candidate short video.

17. The system of claim 16, wherein processing, by the multi-modal neural network system, the multi-modal input to generate the output comprises:
processing, by a live content data model included in the multi-modal neural network system, the multi-modal input to generate interaction data that characterizes interactions between the content creator and the content viewers; and
processing, by a proposer neural network included in the multi-modal neural network system, the multi-modal input and the interaction data to generate the output that comprises the beginning timestamp and the ending timestamp.

18. The system of claim 12, wherein selecting the one or more short videos comprises:
for each time interval in the plurality of successive time intervals, processing, using a selector neural network, (i) the candidate short video generated for the time interval and (ii) a set of one or more content criteria to generate a rating score for each content criterion in the set that measures a degree to which the candidate short video satisfies the content criterion; and
selecting the one or more short videos from the candidate short videos based on the rating scores.

19. The system of claim 12, wherein selecting the one or more short videos comprises:
for each time interval in the plurality of successive time intervals, processing, using a selector neural network, (i) the candidate short video generated for the time interval and (ii) the visual data and audio data included in the creator content stream to generate an importance score that represents a degree to which the candidate short video summarizes content of the creator content stream; and
selecting the one or more short videos from the candidate short videos based on the importance scores.

20. One or more non-transitory computer readable medium storing instructions, that when executed by an artificial intelligence system, causes the artificial intelligence system to perform operations comprising:
obtaining a live stream of video content that comprises a creator content stream and one or more viewer content streams, wherein the creator content stream comprises visual data and audio data provided by a content creator, and wherein each viewer content stream comprises action data that characterizes actions performed by a content viewer while observing the visual data and audio data provided by the content creator;
for each time interval in a plurality of successive time intervals during the live stream of the video content:
generating a candidate short video using a multi-modal neural network system to process a multi-modal input that comprises (i) a portion of the creator content stream that corresponds to the time interval and (ii) for each viewer content stream, a portion of the action data that characterizes actions performed by the content viewer within the time interval, wherein the candidate short video comprises a subset of video frames selected from video frames included in the creator content stream within the time interval and a subset of audio frames selected from audio frames included in the creator content stream within the time interval;
selecting, from the candidate short videos generated for the plurality of successive time intervals during the live stream of the video content, one or more short videos; and
providing the one or more selected short videos for presentation to the content creator.
